(19) United States
(12) Patent Application Publication
(10) Pub. No.: US 2005/0087961 A1
(43) Pub. Date: Apr. 28, 2005

(54) Mounting structure of trim for receiving curtain airbag

(76) Inventor: Won Jong Lee, Ansan (KR)

Correspondence Address: MORGAN, LEWIS & BOCKIUS LLP (SF), 2 PALO ALTO SQUARE, PALO ALTO, CA, 94306, US

(21) Appl. No.: 10/885,170

(22) Filed: Jul. 6, 2004

(30) Foreign Application Priority Data
Oct. 23, 2003 (KR) 10-2003-0074649

(51) Int. Cl. B60R 21/16; B60R 21/22

(52) U.S. Cl. 280/728.2; 280/730.2

(57) ABSTRACT

An installation member whose sides are individually combined with a front pillar part and a trim is furnished within space between the front pillar part and the trim to enable the trim appropriately to separate from the front pillar part upon deployment of a curtain airbag so that deployment of the curtain airbag may be facilitated and that the trim may not completely break away from the front pillar part.

### CROSS-REFERENCE TO RELATED APPLICATIONS

This application claims priority of Korean Application No. 10-2003-0074649, filed Oct. 23, 2003, the disclosure of which is incorporated herein by reference.

### FIELD OF THE INVENTION

This invention relates to a mounting structure of a trim for receiving a curtain airbag, and more specifically, a trim receiving a curtain airbag in the front pillar part of a car body that is kept from breaking away from the front pillar upon deployment of a curtain airbag so that injury to a passenger may be prevented.

### BACKGROUND OF THE INVENTION

A curtain airbag is commonly installed in the space between a front pillar part on a car body side and a trim within the passenger compartment. Upon operation of the air bag, the gap between the said trim and the front pillar part on a car body side widens or breaks away, and the airbag is deployed through the resulting space.

If the said trim completely breaks away from the front pillar part on the car body side upon operation of the airbag, then a passenger may be injured by the trim.

Therefore, the trim is allowed to slightly open or break away from the front pillar part on a car body side so that deployment of a curtain airbag is facilitated, but complete separation is prevented. Various forms of measures are being devised so that separation of a trim from a car body upon deployment of a curtain airbag may not injure a passenger.

### SUMMARY OF THE INVENTION

Embodiments of the present invention provide a mounting structure for a trim for receiving a curtain airbag, wherein the curtain airbag is installed within the space formed by a front pillar part on the car body side and a trim. An additional member is preferably used to firmly secure the rear of the trim to the front pillar part and is supported so that the trim may not break away from the front pillar part upon deployment of a curtain airbag.

A preferred embodiment of the present invention includes a front pillar part of a car body; a trim that is installed within the passenger compartment having a certain space from the front pillar part; a installation member, wherein one side is combined with the said front pillar part in the space formed between the said front pillar part and the trim, and the other side is combined with the trim; and a receiving member that is formed on one side of the said installation member so as to receive a curtain airbag.

### BRIEF DESCRIPTION OF THE DRAWINGS

FIG. 1 is an oblique view illustrating an installation state of a trim for receiving a curtain airbag according to an embodiment of the present invention.

FIG. 2 is a detailed drawing of the installation member illustrated in FIG. 1.

FIG. 3 is a cross-sectional view of FIG. 1 along the III-III line.

FIG. 4 is a cross-sectional view of FIG. 1 along the IV-IV line.

FIG. 5 is a side view illustrating the state in which a curtain airbag has been deployed.

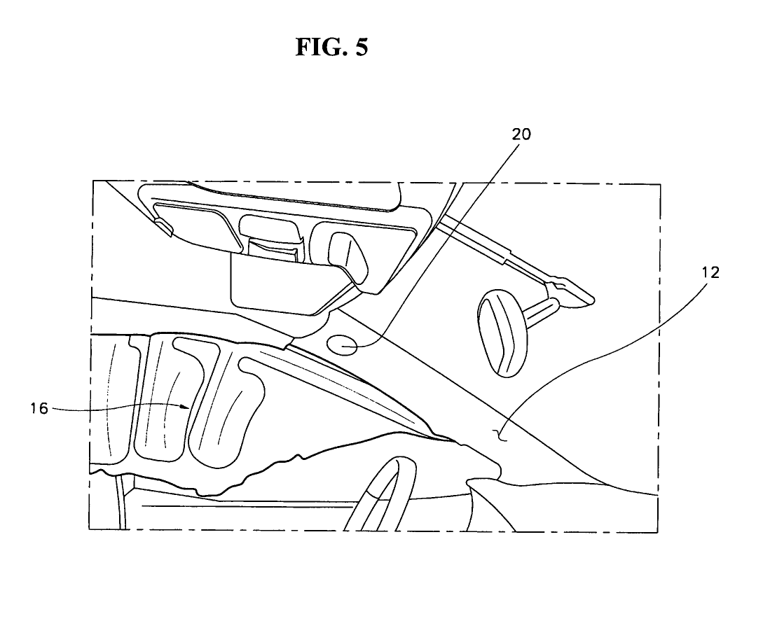

### DETAILED DESCRIPTION OF THE PREFERRED EMBODIMENTS

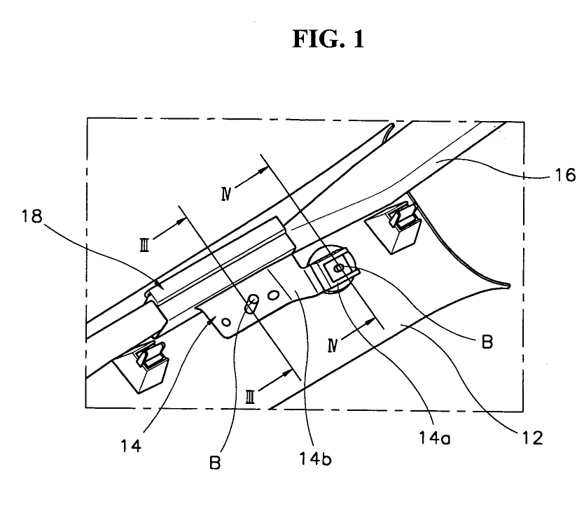

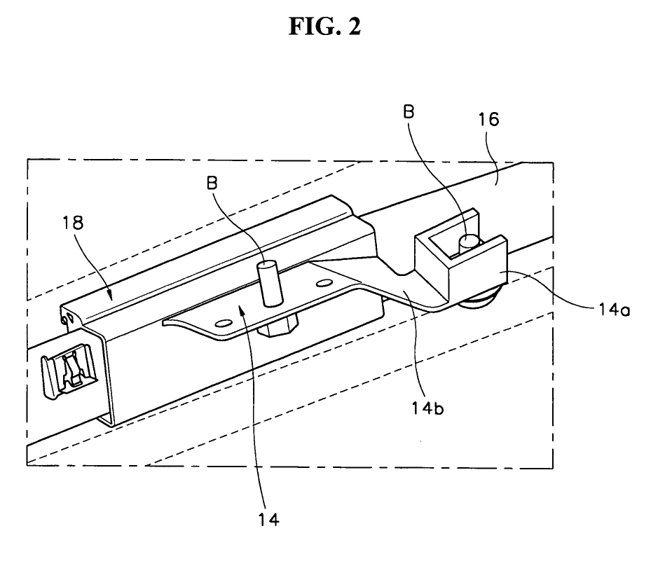

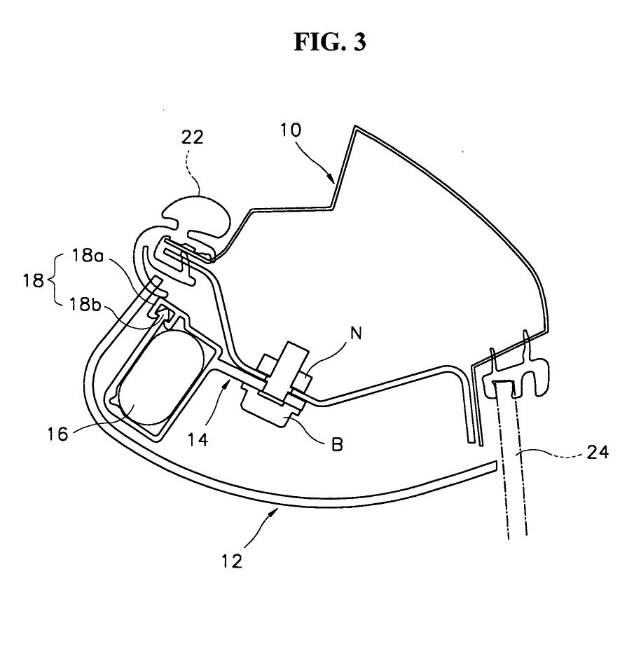

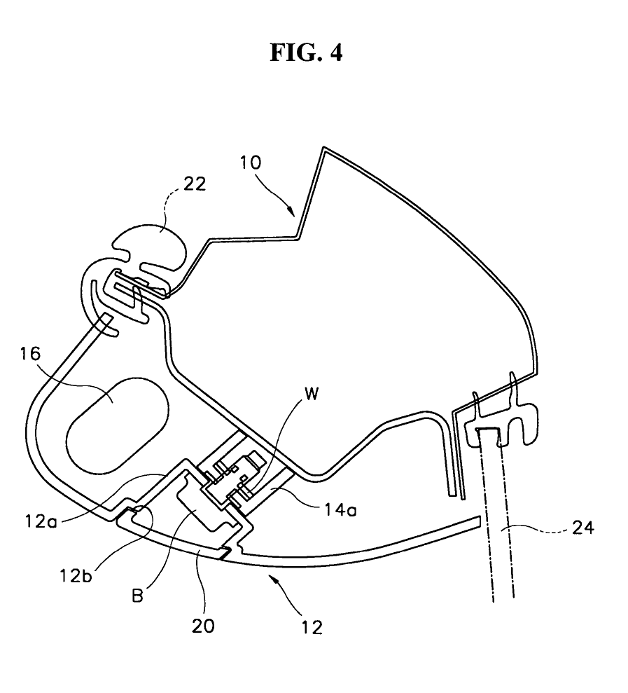

As illustrated in FIG. 1 to FIG. 4, in a preferred embodiment of the present invention, a trim 12 is assembled at the front pillar part 10 of a car body toward the inside of the passenger compartment. Either side of an installation member 14 is fixed to the rear of the front pillar part 10 and the trim 12 within the space formed by the front pillar part 10 and trim 12. The installation member 14 is fixed such that one side is fixed by connecting to the front pillar part 10 with a screw and the other side is also fixed by connecting to the rear of the said trim 12 with a screw.

A receiving member 18 (sometimes referred to as a cab protector) is combined with one side of the installation member 14 that enables deployment of a curtain airbag 16. The receiving member 18 forms a locking groove 18a at one end and also a locking jaw 18b at the other end in one body that combines with the said locking groove 18a. A primary boss part 12a is furnished in the said trim 12 that is formed in a projecting fashion toward the front pillar part 10 to fix the other side of the installation member 14. A seating part 12b is formed as one body at the entrance of the primary boss part 12a whose inner side is in the form of a step. A cap member 20 is separately fabricated from the trim 12, combined with the primary part 12a so as to hide the primary part 12a from outside.

In addition, a secondary boss part 14a is formed in one body at the other side of the installation member 14 to combine with the primary boss part 12a of the trim 12 with a screw. A connection part 14b, which is formed in a somewhat inclined fashion, is furnished between one side and the other side of the said installation member 14.

One side of the installation member 14 is combined with the front pillar part 10 with a fastener such as a bolt (B) and a nut (N). The secondary boss part 14a that is formed on the other side of the installation member 14 is combined with the primary boss part 12a of the trim 12 by a bolt (B) and a washer (W) that plays the role of a nut.

In the drawing, reference numerals 22 and 24 refer to a weather strip that is combined with the front pillar part 10 and a windshield glass, respectively.

Upon deployment of the curtain airbag 16, binding between the locking groove 18a and locking jaw 18b of the receiving member 18 is cancelled, and the trim 12 breaks away from the front pillar part 10 by the curtain airbag 16 undergoing deployment so that deployment of the curtain airbag may be facilitated. Since the trim 12 is not completely separated from the front pillar part 10 by the installation member 14, wherein one end is fixed at the front pillar part 10, and the other end is fixed at the primary boss part 12a of the trim 12, a passenger in the passenger compartment is kept from being injured by the trim 12 that has been separated from the front pillar part 10.

In addition, the connection part 14b of flexible materials that connects the gap between one side and the other side of the installation member 14 in one body enables the location of the other side (secondary boss part) of the installation member with respect to one side of the installation member 14 to move smoothly so that the space between a front pillar part 10 and a trim 12, in which a curtain airbag is deployed, may be easily formed.

As described above, according to the mounting structure of a trim for receiving a curtain airbag by this invention, an installation member is furnished within the space between a front pillar part and a trim whose sides are individually combined with the front pillar part and the trim. The trim appropriately breaks away from the front pillar part upon deployment of a curtain airbag to enable smooth deployment of the curtain airbag and to prevent complete separation of the trim from the front pillar part so that injuries to passengers by complete separation of the trim may be avoided.

1. A mounting structure of a trim for receiving a curtain airbag, comprising:
a front pillar part of a car body;
a trim installed in part around the front pillar part to define a space therebetween;
an installation member, wherein a first portion is secured to the front pillar part in the space formed between the front pillar part and the trim, and a second portion is secured to the trim; and
a receiving member formed on a side of the installation member so as to receive a curtain airbag.

2. The mounting structure as recited in claim 1, further comprising:
a primary boss part formed on the trim in a projecting fashion facing the front pillar part; and
a seating part formed as a step in the trim at an entrance of the primary boss part, such that the installation member may be secured to the primary boss part and a separate cap may be received in the seating part.

3. The mounting structure as recited in claim 1, wherein a secondary boss part is formed in the installation member so said member may be secured to the trim with a connection part of flexible material.

4. The mounting structure as recited in claim 1, wherein the receiving member is furnished with a locking groove formed on one end and a locking jaw formed on the other end that combine to form a closed section.
